(19) United States
(12) Patent Application Publication
(10) Pub. No.: US 2012/0021798 A1
(43) Pub. Date: Jan. 26, 2012

(54) COMMUNICATION DEVICE AND ITS TRANSMISSION POWER CONTROL METHOD IN RADIO COMMUNICATIONS SYSTEM

(75) Inventors: Naoto Ishii, Tokyo (JP); Takahiro Nobukiyo, Tokyo (JP)

(73) Assignee: NEC CORPORATION, Tokyo (JP)

(21) Appl. No.: 13/146,345

(22) PCT Filed: Jan. 8, 2010
(86) PCT No.: PCT/JP2010/000080

§ 371 Date: Jul. 26, 2011

(30) Foreign Application Priority Data
Jan. 26, 2009 (JP) 2009-013779

(51) Int. Cl. H04W 52/04

(52) U.S. Cl. 455/522

(57) ABSTRACT

A transmission power control method and a communication device using it are provided that can prevent the delay of a receipt from increasing and varying in reservation-type scheduling. In a radio communications system in which a radio resource is reserved (step S201) to perform periodical communications between communication devices, the number of retransmissions of a packet transmitted to a communication device by using a reserved radio resource is measured (step S203), and the transmission power of the radio resource is changed depending on the number of retransmissions (steps D204, S205).

### TECHNICAL FIELD

The present invention relates to a radio communications system and, more particularly, to a transmission power control method and a communication device using it.

### BACKGROUND ART

In the Long Term Evolution (LTE) system, of which standardization is currently under way in the 3rd Generation Partnership Project (3GPP), a system band assigned to a base station is divided into small frequency bands called resource blocks, and a resource block is used as a unit of allocation in scheduling.

For applications in which data do not occur on a constant period basis, such as web page browser and file transfer, employed is dynamic scheduling DS in which radio resources (resource block, transmission interval, transmission power, etc.) to be used can be changed for each transmission, depending on the communication channel quality on the receiving side. In the dynamic scheduling DS, it is necessary to notify which radio resources are used for each transmission, by using a control channel that is different from a data channel.

On the other hand, for scheduling schemes for periodic-data-occurrence traffic such as Voice over Internet Protocol (VoIP), a reservation-type scheduling scheme called persistent scheduling PS is proposed (for example, see NPL 1). The reservation-type scheduling is a scheduling scheme in which, using the fact that data occur at constant intervals as in the case of VoIP or the like, radio resources for a first-transmitted packet are reserved for the following packets.

In the persistent scheduling PS, a notification made using a control channel is not required because radio resources for a first-transmitted packet are reserved. Accordingly, radio resources assigned to the control channel can be saved, and efficiency in the use of frequency can be enhanced. Moreover, when the sending side reserves resources, a generally conceivable procedure is that referring to the average quality of the communication channels in the system band, a frequency band and a coding rate for error correction codes are determined, and then resource blocks are allocated sequentially, starting with those unreserved.

Regarding transmission power in the persistent scheduling PS, multilevel modulation such as quadrature amplitude modulation (QAM) is used in downlink, and information is contained also in amplitude. Accordingly, although transmission power can be changed at long intervals, specific power in the system band is generally constant.

### CITATION LIST

### Non-Patent Literature

[NPL 1]
3GPP TS36.300 V8.5.0 (2008-05), 3GPP E-UTRA and E-UTRAN Overall description, pp. 62-63

### SUMMARY OF INVENTION

### Technical Problem

However, in reservation-type scheduling such as the persistent scheduling PS, since a first-transmitted packet is transmitted at constant intervals in accordance with data occurrence periods, no due consideration is given to variation over time in individual resource blocks used for transmission. Since having a terminal give a report on the quality of a downlink communication channel in the form of the average value of resource block units leads to an additional use of uplink resources, it is assumed that the average quality of the communication channels in the system band is reported.

Therefore, when the received quality is degraded because of fading and/or interference from a neighboring cell, the frequency of retransmission rises, and a delay increases. Moreover, a change in the number of retransmissions due to variation in the communication channel quality over time will result in a change in the period of time taken before the receipt of a packet is completed. This causes the period of time taken before a packet is normally received to vary from packet to packet on the receiving side, even if each packet is transmitted at constant intervals on the sending side.

Accordingly, an object of the present invention is to provide a transmission power control method that can prevent the delay of a receipt from increasing and varying in reservation scheduling, as well as a radio communication system and a communication device using the method.

### Solution to Problem

A transmission power control method according to the present invention is a transmission power control method in a radio communication system in which communication between communication devices is periodically made by reserving a radio resource, includes: measuring count of retransmissions of a packet transmitted using a reserved radio resource; and changing transmission power of the reserved radio resource depending on the count of retransmissions.

A communication device according to the present invention is a communication device in a radio communication system in which communication with another communication device is periodically made by reserving a radio resource, includes: a measurement section for measuring count of retransmissions of a packet transmitted using a reserved radio resource; and a transmission power control section for changing transmission power of the reserved radio resource depending on the count of retransmissions.

A radio communication system according to the present invention is a radio communication system comprising at least one base station and at least one mobile terminal which periodically make communication with each other using a reserved radio resource, wherein the base station comprises: a measurement section for measuring count of retransmissions of a packet transmitted using the reserved radio resource; and a transmission power control section for changing transmission power of the reserved radio resource depending on the count of retransmissions.

A computer program according to the present invention is a computer program which functioning a program-controlled processor as a communication device in which communication between communication devices is periodically made by reserving a radio resource, includes: a function of measuring count of retransmissions of a packet transmitted using a reserved radio resource; and a function of changing transmission power of the reserved radio resource depending on the count of retransmissions.

### ADVANTAGEOUS EFFECTS OF INVENTION

According to the present invention, it is possible to prevent the delay of a receipt from increasing and varying in reservation-type scheduling.

### BRIEF DESCRIPTION OF DRAWINGS

FIG. 1 is a block diagram schematically showing part of the configuration of a communication device, the part relevant to transmission power control, according to a first exemplary embodiment of the present invention.

FIG. 2 is a flowchart showing a transmission power control method, performed in the communication device according to the first exemplary embodiment.

FIG. 3 is a block diagram showing the structure of a mobile communications system including multiple mobile stations and a base station to which a communication device according to a second exemplary embodiment of the present invention is applied.

FIG. 4 is a schematic block diagram showing an example of the configuration of the base station to which the communication device according to the second exemplary embodiment of the present invention is applied.

FIG. 5 is a resource structure diagram showing the reservation states of resource blocks used in reservation-type scheduling in the second exemplary embodiment.

FIG. 6A is a diagram showing the transmission powers for individual terminals and the numbers of retransmissions that have been made for the individual terminals before transmission power reassignment control according to the second exemplary embodiment is performed. FIG. 6B is a diagram showing the transmission powers for the individual terminals after the transmission power reassignment control is performed.

FIG. 7 is a flowchart showing a transmission power reassignment control method according to the second exemplary embodiment.

### DESCRIPTION OF EMBODIMENTS

### 1. First Exemplary Embodiment

### 1.1) Configuration

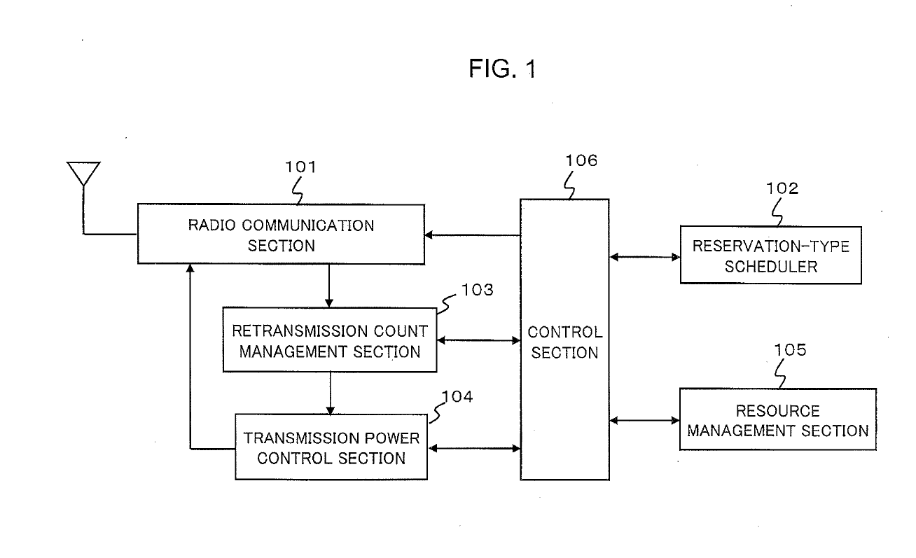

FIG. 1 is a block diagram schematically showing part of the configuration of a communication device, the part relevant to transmission power control, according to a first exemplary embodiment of the present invention. Here, a radio communication section 101 is a collective block including a transmission section, a reception section, a channel control section, and the like for a general radio communications system and is assumed to have a transmission power change function, a retransmission function such as hybrid automatic repeat request (Hybrid ARQ), and the like.

A reservation-type scheduler 102 has a function of allocating a radio resource to a reservation-type traffic packet. A retransmission count management section 103 manages the number of retransmissions of each packet transmitted by the radio communication section 101. A transmission power control section 104 changes transmission power for each resource block, depending on the number of retransmissions. A resource management section 105 has a function of managing the reservation state of each resource block, which is a unit of allocation in a radio band, and the transmission power of each resource block. A control section 106 controls the overall operation of the communication device. Here, however, a description will be given of transmission power control.

### 1.2) Operation

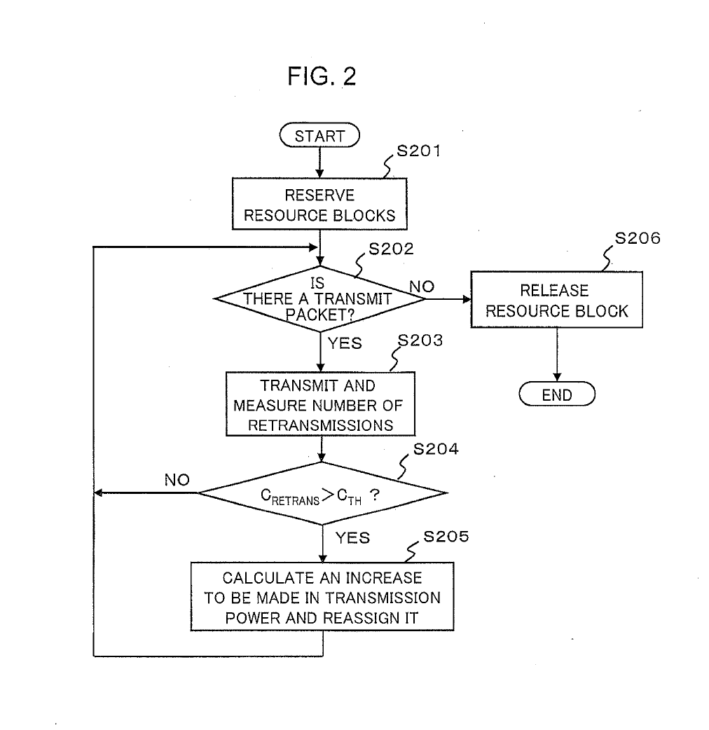

FIG. 2 is a flowchart showing a transmission power control method, performed in the communication device according to the present exemplary embodiment. The control section 106, upon arrival of a packet that occurs periodically like those of VoIP, causes the reservation-type scheduler 102 to reserve resource blocks (step S201). Specifically, the reservation-type scheduler 102 checks the resource reservation states kept in the resource management section 105, reserves resource blocks at constant intervals, updates the resource reservation states in the resource management section 105, and notifies the control section 106 of the result of the resource block allocation. Note that the method of reserving a resource block for the first packet is well known and therefore a detailed description of the reservation operation will be omitted.

The control section 106 determines whether or not there is a packet to transmit (step S202). If there is one (step S202: YES), the control section 106 has the radio communication section 101 transmit the packet by using the resource block reserved by the reservation-type scheduler 102. In this event, the retransmission count management section 103, under the control of the control section 106, counts the number of retransmissions when the packet in question is retransmitted (step S203).

The control section 106 performs transmission power change control depending on the number of retransmissions. Specifically, the control section 106 determines whether or not the number of retransmissions (C_{RETRANS}) exceeds a threshold value (C_{TH}) within a predetermined range (step S204). When the number of retransmissions is not greater than the predetermined threshold value (step S204: NO), the control section 106 does not change the transmission power, and the process goes back to the step S202 where the control section 106 checks whether or not there is a packet to transmit. When the number of retransmissions exceeds the predetermined threshold value (step S204: YES), the control section 106 causes the transmission power control section 104 to calculate an increase to be made in the transmission power (step S205). The transmission power control section 104 performs transmission power reassignment based on the resource block reservation states managed by the resource management section 105 and then updates the reservation states in the resource management section 105. Thereafter, under the control of the control section 106, the radio communication section 101, if there is a packet to subsequently transmit (step S202: YES), carries out transmission of the packet by using the reserved resource block at the increased transmission power (step S203). The above-described steps S202 to S205 are repeated as long as there is data to transmit by using the reserved resource block.

When there is no packet to transmit (step S202: NO), the control section 106 updates the reservation states in the resource management section 105 so that the reserved resource block is released (step S206).

Note that the functions for the transmission power reassignment control performed by the reservation-type scheduler 102, retransmission count management section 103, transmission power control section 104, resource management section 105, and control section 106 as described above can also be implemented similarly by executing a computer program on a program-controlled processor such as a CPU.

### 1.3) Effects

As described above, according to the present exemplary embodiment, the number of retransmissions is measured for each resource block reserved and allocated, and the transmission power is changed depending on the number of retransmissions. More preferably, when retransmissions are frequent (the number of retransmissions exceeds a predetermined value), the transmission power of the resource block reserved is increased. Since an increase in transmission power reduces the number of retransmissions, it is possible to reduce the delay of a packet and to suppress variations of the delay in the reservation-type scheduling scheme. Moreover, the reduced number of retransmissions increases available radio resources, thereby also obtaining an effect of increasing efficiency in the use of radio resources.

### 2. Second Exemplary Embodiment

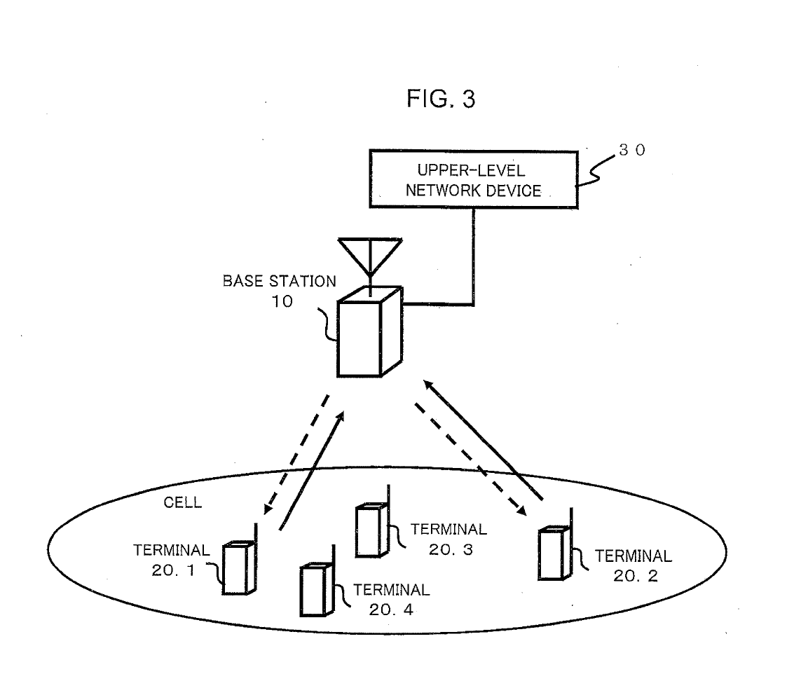

FIG. 3 is a block diagram showing the structure of a mobile communications system including multiple mobile stations and a base station to which a communication device according to a second exemplary embodiment of the present invention is applied. Here, to avoid complicating description, it is assumed that a plurality of mobile terminals 20.1 to 20.4 are located in the cell of a base station 10 and that the base station 10 is connected to an upper-level network device 30.

### 2.1) Configuration

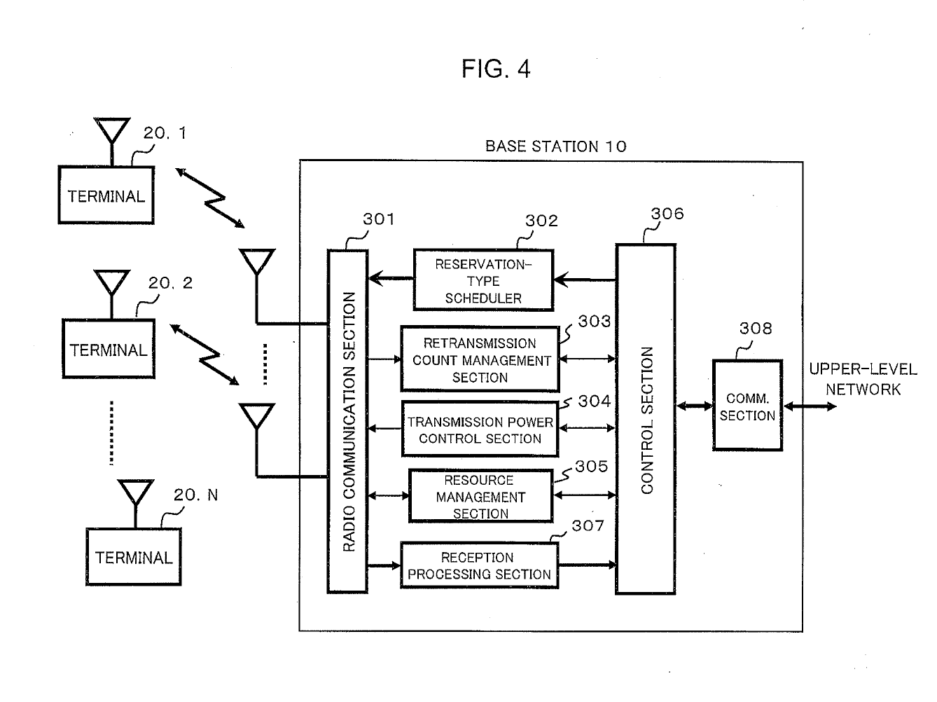

FIG. 4 is a schematic block diagram showing an example of the configuration of the base station to which the communication device according to the second exemplary embodiment of the present invention is applied.

The base station 10 includes a radio communication section 301 that performs radio communication with the mobile terminals, as well as a reservation-type scheduler 302, a retransmission count management section 303, a transmission power control section 304, a resource management section 305, and a control section 306. In addition, the base station 10 further includes a reception processing section 307 for processing an uplink signal received from each mobile terminal, and a communication section 308 that transmits data for transfer in the uplink signals to the upper-level network device 30 (base station controller) and also receives data from the upper-level network device 30.

Note that the respective functions of the reservation-type scheduler 302, retransmission count management section 303, transmission power control section 304, resource management section 305, control section 306, and reception processing section 307 can also be implemented by executing their respective corresponding programs on a program-controlled processor such as a CPU. Additionally, shown here is mainly the part relevant to the transmission power reassignment control according to the present invention, with other constituents being omitted. Hereinafter, a description will be given of a radio communications system, using a downlink as an example.

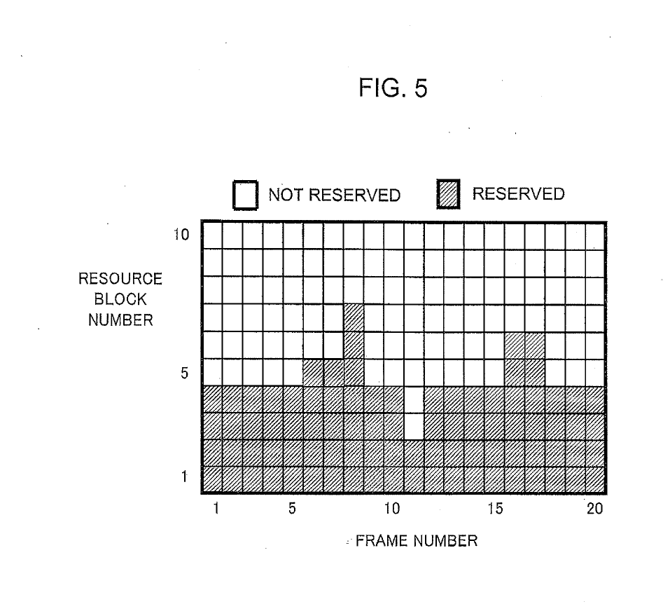

FIG. 5 is a resource structure diagram showing the reservation states of resource blocks used in the reservation-type scheduling in the second exemplary embodiment. Here, the horizontal axis represents time orientation indicated with frame numbers, and twenty frames are assumed to correspond to a period of packet transmission. Moreover, the vertical axis represents frequency indicated with resource block numbers. A system band assigned to the base station 10 is divided into small frequency bands called resource blocks, and a resource block is a unit of allocation in scheduling.

In persistent scheduling PS, the resource management section 305 manages the reservation states of resource blocks and the transmission power of each resource block as shown in FIG. 5. However, in FIG. 5, it is assumed that the transmission powers are the same for all the blocks. Note that a resource block is a logical one and may be a different frequency from one actually used in transmission. This is because it is sufficient that a logical resource block managed and a physical resource block used in actual transmission have a one-to-one correspondence. In addition, although FIG. 5 shows ten resource blocks per transmission frame and twenty transmission frames as an example, the numbers are not limited to these.

As described above, in persistent scheduling PS, when a packet for which no reservation is made has arrived, the reservation-type scheduler 302 refers to the resource reservation states shown in FIG. 5 and determines whether or not there is any resource block that is not allocated. The reservation-type scheduler 102 makes reservation depending on the number of the resource blocks that are not allocated. Once reservation is made, transmission can be performed with respect to subsequently arriving packets of the same communication, using the reserved resource block and transmission frame. Note that, when a transmitted packet is not received normally, the control section 306 performs control such that the packet will be retransmitted through dynamic scheduling DS by using a non-reserved resource block (or reservation may be made for retransmission).

2.2) Transmission power reassignment control

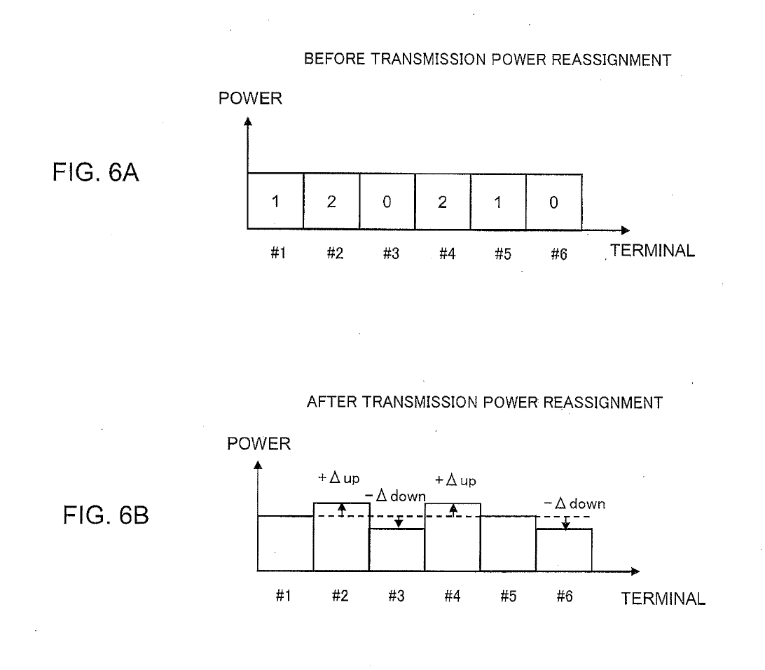

FIG. 6A is a diagram showing the transmission powers for individual terminals and the numbers of retransmissions that have been made for the individual terminals before the transmission power reassignment control according to the second exemplary embodiment is performed, and FIG. 6B is a diagram showing the transmission powers for the individual terminals after the transmission power reassignment control is performed. Here, shown are the transmission powers with respect to a certain transmission frame, and it is assumed that six terminals #1 to #6 simultaneously perform communication. Moreover, it is assumed that 1, 2, 0, 2, 1, and 0 retransmissions have been made for the terminals #1 to #6, respectively, as shown in FIG. 6A. Note that the number of resource blocks allocated for each terminal is not shown because the transmission powers of the resource blocks allocated for one individual terminal are equal to each other.

In the example shown in FIG. 6B, the transmission powers for the mobile terminals #2 and #4, for which two retransmissions or more have been made, are increased by Δup each, the transmission powers for the mobile terminals #1 and #5, for which one retransmission has been made, are not changed, and the transmission powers for the mobile terminals #3 and #6, for which fewer than one transmission has been made, are reduced by Δdown each. Since the base station 10 has a fixed maximum amount of transmission power and a fixed minimum amount of transmission power, changes in the assignment of transmission power are made such that the newly assigned transmission powers will not be beyond these boundaries, which will be described later. Hereinafter, the transmission power control will be described in more detail.

According to the present exemplary embodiment, a power greater than the maximum power fixed for the base station 10 cannot be assigned. Therefore, the transmission power reassignment control is performed in two steps, in which, first, it is determined whether or not the power for a terminal thought to have too high quality can be reduced, and subsequently, the sum of a current surplus power and the amount of a reduction made in the power for the too-high-quality terminal is given for a terminal having low quality.

Note that, as mentioned above, although the power per resource block (RB) assigned for a terminal varies from terminal to terminal, the powers of the resource blocks (RB) allocated for one individual terminal are equal to each other. Accordingly, there are some cases where although the same number of resource blocks is allocated for different terminals, the power assigned for a terminal varies from terminal to terminal. Conversely, there may also be cases where even if different numbers of resource blocks are allocated for terminals, the same powers are assigned for the terminals.

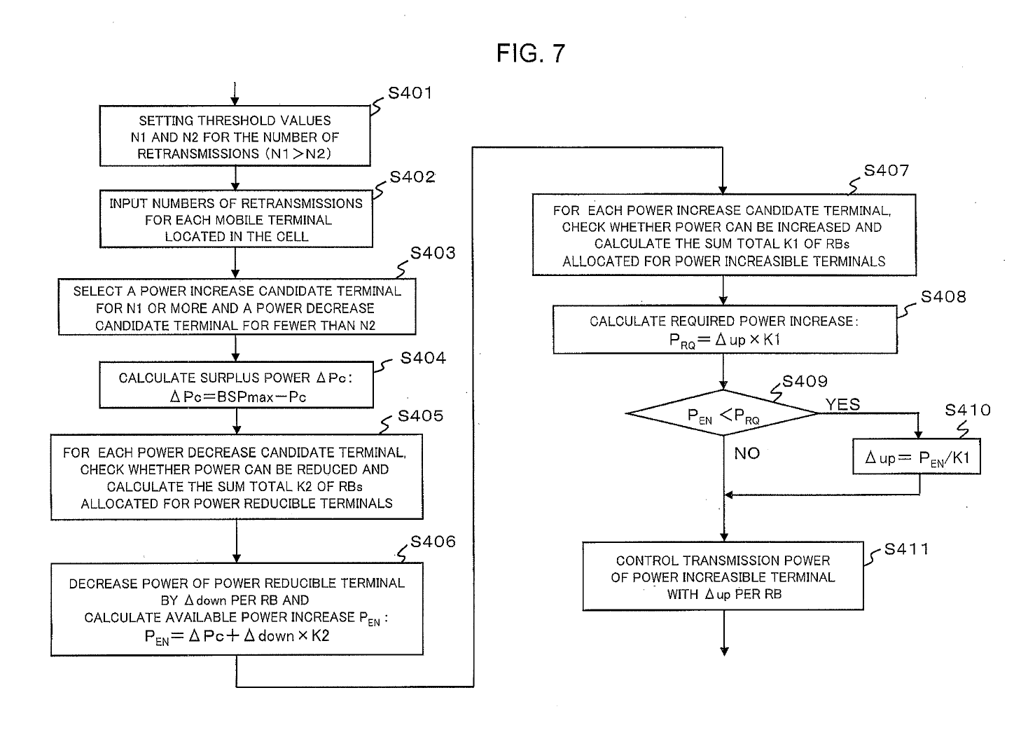

FIG. 7 is a flowchart showing a transmission power reassignment control method according to the present exemplary embodiment. Here, for the number of retransmissions, predetermined threshold values N1 and N2 are preset, as shown in a step S401. Note that N1>N2.

The control section 306 receives as input, from the retransmission count management section 303, the numbers of retransmissions made for mobile terminals located in the cell (step S402). The control section 306 selects a terminal for which N1 retransmissions or more have been made, as a candidate for increase in transmission power, and selects a terminal for which fewer than N2 retransmissions have been made, as a candidate for decrease in transmission power (step S403). Here, it is assumed that a1 is the number of candidate terminals for increase in transmission power, and that a2 is the number of candidate terminals for decrease in transmission power. For example, assuming that N1=2 and N2=1, in FIG. 6A, the mobile terminals #2 and #4 are candidate terminals for increase in transmission power (a1=2), and the mobile terminals #3 and #6 are candidate terminals for decrease in transmission power (a2=2).

First, the transmission power control section 304 calculates a surplus power ΔPc (=BSPₘₐₓ−Pc), which is the difference between a maximum transmission power BSPₘₐₓ fixed for the base station 10 and a current transmission power Pc before changes in transmission power are made (step S404). Here, the current transmission power Pc corresponds to the total of the powers assigned to all resource blocks.

Subsequently, the transmission power control section 304 checks, for each candidate terminal for decrease in transmission power, whether or not the power of a resource block can be reduced by down (step S405). Here, Δdown is a predetermined amount of decrease in the power per resource block. The determination as to whether or not the power can be reduced is performed as follows.

Assume that P_{RB}(i) is the current transmission power of a resource block allocated for a candidate terminal i (i=1 to a2) for decrease in transmission power, and that Pₘᵢₙ is a minimum transmission power. If P_{RB}(i)−Δdown≧Pₘᵢₙ, the transmission power for the terminal i can be reduced. If P_{RB}(i)−Δdown<Pₘᵢₙ, the transmission power for the terminal i is not changed.

When terminals for which transmission power can be reduced have been determined in this manner, the sum total K2 of the resource blocks allocated for these terminals is calculated.

Accordingly, the transmission powers for the terminals for which transmission power can be reduced can be reduced by Δdown×K2, by reducing the transmission power per resource block by Δdown. Adding the current surplus power ΔPc, an available power increase P_{EN} in total is obtained as follows (step S406):

P_{EN}=ΔPc+Δdown×K2.

When the available power increase P_{EN} has been calculated, the transmission power control section 304 determines how the available power increase P_{EN} is allocated to the candidate terminals for increase in transmission power. First, for each of the candidate terminals for increase in transmission power, the transmission power control section 304 checks whether or not the power of a resource block can be increased by Δup (step S407). Here, Δup is a predetermined amount of increase in the power per resource block. The determination as to whether or not the power can be increased is performed as follows.

Assume that P_{RB}(j) is the current transmission power of a resource block allocated for a candidate terminal j (j=1 to a1) for increase in transmission power, and that Pₘₐₓ is a maximum transmission power. If P_{RB}(j)+Δup≦Pₘₐₓ, the transmission power for the terminal j can be increased. If P_{RB}(j)+Δup>Pₘₐₓ, the transmission power for the terminal j is not changed.

When terminals for which transmission power can be increased have been determined in this manner, the sum total K1 of the resource blocks allocated for these terminals is calculated. Accordingly, a transmission power increase P_{RQ} required by the terminals for which transmission power can be increased can be calculated as follows (step S408): P_{RQ}=Δup×K1.

Next, the transmission power control section 304 compares the available power increase P_{EN} and the required power increase P_{RQ} (step S409). When the available power increase P_{EN} is equal to or greater than the required power increase P_{RQ} (step S409: NO), the per-resource-block power increase Δup is used as it is. When the available power increase P_{EN} is smaller than the required power increase P_{RQ} (step S409: YES), the per-resource-block power increase Δup is reduced to P_{RQ}/K1 (step S410).

Using the thus obtained per-resource-block power increase Δup, transmission power control is performed on the terminals for which transmission power can be increased (step S411).

### 2.3) Effects

As described above, according to the second exemplary embodiment of the present invention, the following effects can be obtained in addition to the effects of the first exemplary embodiment of the present invention. That is, the number of retransmissions is measured for each resource block reserved and allocated. A terminal for which the predetermined number N1 of retransmissions or more have been made is selected as a candidate terminal for increase in transmission power, and a terminal for which retransmissions fewer than the predetermined number N2 have been made is selected as a candidate terminal for decrease in transmission power. Then, among the candidate terminals for decrease in transmission power, a reduction is made in the transmission power of a terminal whose transmission power does not go below the minimum transmission power, whereby it is possible to increase the available power increase that can be allocated among the candidate terminals for increase in transmission power. Thus, it is possible to achieve efficient and effective transmission power control.

Note that the present invention is not intended to be applied only to LTE systems, but can be applied to radio communications systems using frequency division multiple access (FDMA).

### INDUSTRIAL APPLICABILITY

The present invention is applicable to radio communications system and, more particularly, can be employed in radio communications system using LTE or FDMA, for example.

### REFERENCE SIGNS LIST

10 Base station
20 Mobile terminal
30 Upper network device
101 Radio communication section
102 Reservation-type scheduler
103 Retransmission count management section
104 Transmission power control section
105 Resource management section
106 Control section
301 Radio communication section
302 Reservation-type scheduler
303 Retransmission count management section
304 Transmission power control section
305 Resource management section
306 Control section
307 Reception processing section
308 Communication section

1. A method for controlling transmission power in a radio communication system in which communication devices communicate periodically by using a reserved radio resource, comprising:
counting the number of retransmissions of a packet transmitted using the reserved radio resource; and
controlling transmission power of the reserved radio resource depending on the number of retransmissions.

2. The method according to claim 1, wherein the transmission power of the reserved radio resource is increased when the number of retransmissions is equal to or greater than a first predetermined value.

3. The method according to claim 2, wherein the transmission power of the reserved radio resource is decreased when the number of retransmissions is smaller than a second predetermined value, which is smaller than the first predetermined value.

4. The method according to claim 1, wherein, when the number of retransmissions is equal to or greater than a first predetermined value and a current transmission power plus a predetermined amount of increase in transmission power of the reserved radio resource exceeds a first transmission power value, the transmission power of the reserved radio resource is not changed.

5. The method according to claim 1, wherein, when the number of retransmissions is smaller than a second predetermined value which is smaller than the first predetermined value and a current transmission power minus a predetermined amount of decrease in transmission power of the reserved radio resource is less than a second transmission power value which is smaller than the first transmission power value, the transmission power of the reserved radio resource is not changed.

6. The method according to claim 1, wherein the transmission power of the reserved radio resource is changed by:
increasing the amount of transmission power of a reserved radio resource used for each of a plurality of communications when the number of retransmissions of a packet is equal to or greater than a first predetermined value;
decreasing the amount of transmission power of a reserved radio resource used for each of the plurality of communications when the number of retransmissions of a packet is smaller than a second predetermined value which is smaller than the first predetermined value; and
changing the transmission power of each reserved radio resource so that a required power increase, which is a total of increased amounts of transmission power, is made equal to or smaller than an available power increase, which is obtained by adding a total of decreased amounts of transmission power to a currently-available transmission power.

7. The method according to claim 6, wherein, when the number of retransmissions is equal to or greater than the first predetermined value and a current transmission power plus a predetermined amount of increase in transmission power of the reserved radio resource exceeds a first transmission power value, the transmission power of the reserved radio resource is not changed.

8. The method according to claim 7, wherein, when the number of retransmissions is smaller than the second predetermined value and a current transmission power minus a predetermined amount of decrease in transmission power of the reserved radio resource is less than a second transmission power value which is smaller than the first transmission power value, the transmission power of the reserved radio resource is not changed.

9. A communication device in a radio communication system, wherein the communication device communicates periodically with another communication device by using a reserved radio resource, comprising:
a measurement section configured to count the number retransmissions of a packet transmitted using the reserved radio resource; and
a transmission power control section configured to control transmission power of the reserved radio resource depending on the number of retransmissions.

10. The communication device according to claim 9, wherein the transmission power control section configured to increase the transmission power of the reserved radio resource when the number of retransmissions is equal to or greater than a first predetermined value.

11. The communication device according to claim 10, wherein the transmission power control section configured to decrease the transmission power of the reserved radio resource when the number of retransmissions is smaller than a second predetermined value, which is smaller than the first predetermined value.

12. The communication device according to claim 9, wherein, when the number of retransmissions is equal to or greater than a first predetermined value and a current transmission power plus a predetermined amount of increase in transmission power of the reserved radio resource exceeds a first transmission power value, the transmission power control section configured not to change the transmission power of the reserved radio resource.

13. The communication device according to claim 12, wherein, when the number of retransmissions is smaller than a second predetermined value which is smaller than the first predetermined value, and a current transmission power minus a predetermined amount of decrease in transmission power of the reserved radio resource is less than a second transmission power valueₛ which is smaller than the first transmission power value, the transmission power control section configured not to change the transmission power of the reserved radio resource.

14. The communication device according to claim 9, wherein the transmission power control section configured to
increase the amount of transmission power of a reserved radio resource used for each of a plurality of communications when the number of retransmissions of a packet for each communication is equal to or greater than a first predetermined value;
decrease the amount of transmission power of a reserved radio resource used for each of the plurality of communications when the number of retransmissions of a packet for each communication is smaller than a second predetermined value, which is smaller than the first predetermined value; and
change the transmission power of each reserved radio resource so that a required power increase which is a total of increased amounts of transmission power is made equal to or smaller than an available power increase which is obtained by adding a total of decreased amounts of transmission power to a currently-available transmission power.

15. The communication device according to claim 14, wherein, when number of retransmissions is equal to or greater than a first predetermined value and a current transmission power plus a predetermined amount of increase in transmission power of the reserved radio resource exceeds a first transmission power value, the transmission power control section configured not to change the transmission power of the reserved radio resource.

16. The communication device according to claim 15, wherein, when the number of retransmissions is smaller than a second predetermined value which is smaller than the first predetermined value and a current transmission power minus a predetermined amount of decrease in transmission power of the reserved radio resource is less than a second transmission power value, which is smaller than the first transmission power value, the transmission power control section configured not to change the transmission power of the reserved radio resource.

17. A base station in the radio communication system, comprising the communication device according to claim 9.

18. A radio communication system comprising at least one base station and at least one mobile terminal which periodically communicate with each other using a reserved radio resource,
wherein the base station comprises:
a measurement section configured to count the number of retransmissions of a packet transmitted using the reserved radio resource; and
a transmission power control section configured to control transmission power of the reserved radio resource depending on the number of retransmissions.

19. The radio communication system according to claim 18, wherein the transmission power control section configured to increase the transmission power of the reserved radio resource when the number of retransmissions is equal to or greater than a first predetermined value.

20. The radio communication system according to claim 19, wherein the transmission power control section configured to decrease the transmission power of the reserved radio resource when the number of retransmissions is smaller than a second predetermined value, which is smaller than the first predetermined value.

21. The radio communication system according to claim 18, wherein, when the number of retransmissions is equal to or greater than a first predetermined value and a current transmission power plus a predetermined amount of increase in transmission power of the reserved radio resource exceeds a first transmission power value, the transmission power control section configured not to change the transmission power of the reserved radio resource.

22. The radio communication system according to claim 21, wherein, when the number of retransmissions is smaller than a second predetermined value which is smaller than the first predetermined value and a current transmission power minus a predetermined amount of decrease in transmission power of the reserved radio resource is less than a second transmission power value which is smaller than the first transmission power value, the transmission power control section configured not to change the transmission power of the reserved radio resource.

23. The radio communication system according to claim 18, wherein the transmission power control section configured to
increase the amount of transmission power of a reserved radio resource used for each of a plurality of communications when the number of retransmissions of a packet for each communication is equal to or greater than a first predetermined value;
decrease the amount of transmission power of a reserved radio resource used for each of the plurality of communications when the number of retransmissions of a packet for each communication is smaller than a second predetermined value which is smaller than the first predetermined value; and
change the transmission power of each reserved radio resource so that a required power increase, which is a total of increased amounts of transmission power, is made equal to or smaller than an available power increase, which is obtained by adding a total of decreased amounts of transmission power to a currently-available transmission power.

24. The radio communication system according to claim 23, wherein, when the number of retransmissions is equal to or greater than a first predetermined value and a current transmission power plus a predetermined amount of increase in transmission power of the reserved radio resource exceeds a first transmission power value, the transmission power control section configured not to change the transmission power of the reserved radio resource.

25. The radio communication system according to claim 24, wherein, when the number of retransmissions is smaller than a second predetermined value, which is smaller than the first predetermined value, and an a current transmission power minus a predetermined amount of decrease in transmission power of the reserved radio resource is less than a second transmission power value, which is smaller than the first transmission power value, the transmission power control section configured not to change the transmission power of the reserved radio resource.

26. A computer readable information recording medium storing a program which, when executed by a processor, performs a method for controlling transmission power in a radio communication system in which communication devices communicate periodically by a reserved radio resource comprising:
counting the number of retransmissions of a packet transmitted using the reserved radio resource; and
controlling transmission power of the reserved radio resource depending on the number of retransmissions.

27. The computer readable information recording medium according to claim 26, wherein the transmission power of the reserved radio resource is increased when the number of retransmissions is equal to or greater than a first predetermined value.

28. The computer readable information recording medium according to claim 27, wherein the transmission power of the reserved radio resource is decreased when the number of retransmissions is smaller than a second predetermined value, which is smaller than the first predetermined value.

29. The computer readable information recording medium according to claim 26, wherein, when the number of retransmissions is equal to or greater than a first predetermined value and a current transmission power plus a predetermined amount of increase in transmission power of the reserved radio resource exceeds a first transmission power value, the transmission power of the reserved radio resource is not changed.

30. The computer readable information recording medium according to claim 29, wherein, when the number of retransmissions is smaller than a second predetermined value which is smaller than the first predetermined value and a current transmission power minus a predetermined amount of decrease in transmission power of the reserved radio resource is less than a second transmission power value which is smaller than the first transmission power value, the transmission power of the reserved radio resource is not changed.

31. The computer readable information recording medium according to claim 26, wherein the transmission power of the reserved radio resource is changed by:
increasing the amount of transmission power of a reserved radio resource used for each of a plurality of communications when the number of retransmissions of a packet is equal to or greater than a first predetermined value;
decreasing the amount of transmission power of a reserved radio resource used for each of the plurality of communications when the number of retransmissions of a packet is smaller than a second predetermined value which is smaller than the first predetermined value; and
changing the transmission power of each reserved radio resource so that a required power increase, which is a total of increased amounts of transmission power, is made equal to or smaller than an available power increase, which is obtained by adding a total of decreased amounts of transmission power to a currently-available transmission power.

32. The computer readable information recording medium according to claim 31, wherein, when the number of retransmissions is equal to or greater than the first predetermined value and a current transmission power plus a predetermined amount of increase in transmission power of the reserved radio resource exceeds a first transmission power value, the transmission power of the reserved radio resource is not changed.

33. The computer readable information recording medium according to claim 32, wherein, when the number of retransmissions is smaller than the second predetermined value and a current transmission power minus a predetermined amount of decrease in transmission power of the reserved radio resource is less than a second transmission power value which is smaller than the first transmission power value, the transmission power of the reserved radio resource is not changed.
